(19) United States
(12) Patent Application Publication
(10) Pub. No.: US 2012/0075054 A1
(43) Pub. Date: Mar. 29, 2012

(54) ELECTRONIC DEVICE WITH SELF-LEARNING FUNCTION AND INTELLIGENT CONTROL METHOD THEREOF

(75) Inventors: RONG GE, Shenzhen City (CN); HUA-DONG CHENG, Shenzhen City (CN); CHIH-SAN CHIANG, Tu-Cheng (TW); HAN-CHE WANG, Tu-Cheng (TW)

(73) Assignees: HON HAI PRECISION INDUSTRY CO., LTD., Tu-Cheng (TW); HONG FU JIN PRECISION INDUSTRY (ShenZhen) CO.,LTD., Shenzhen City (CN)

(21) Appl. No.: 13/077,953

(22) Filed: Mar. 31, 2011

(30) Foreign Application Priority Data
Sep. 27, 2010 (CN) 201010293425.8

(51) Int. Cl. G05B 23/02

(52) U.S. Cl. 340/3.1

(57) ABSTRACT

An electronic device with self-learning function includes an input unit, a state detecting unit, a state recording unit, a state analysis unit, and a processing unit. The input unit generates input signals according to operations of a user. The state detecting unit detects real-time values of the state parameters. The state recording unit obtains the real-time values of predetermined state parameters when the input signals are received. The state analysis unit analyzes whether the times of an operation under a same state parameter value or in same state parameter value range has reached or equal to a predetermined number of times within a predetermined time period. If yes, the state analysis unit determines the operation is a habit and the state parameter value corresponding to the operation is the state parameter value of the habit. The processing unit executes a task corresponding to the habit.

### BACKGROUND

1. Technical Field

The present disclosure relates to an electronic device with self-learning function and an intelligent control method thereof.

2. Description of Related Art

Users are allowed to change parameter settings of many electronic devices. However, the electronic device cannot automatically adjust the parameter settings according to the changed habits and preferences of the user. The user needs to manually change the parameter settings of the electronic device to fit their tastes, which is time consuming and inconvenient for users.

Therefore, what is needed is an electronic device with self-learning function and an intelligent control method thereof alleviating the limitations described above.

### BRIEF DESCRIPTION OF THE DRAWINGS

The components in the drawings are not necessarily drawn to scale, the emphasis instead being placed upon clearly illustrating the principles of an electronic device with self-learning function and an intelligent control method thereof. Moreover, in the drawings, like reference numerals designate corresponding parts throughout the several views.

FIG. 1 is a block diagram illustrating an electronic device with self-learning function, according to an exemplary embodiment.

FIG. 2 is a flowchart of an intelligent control method of the electronic device with self-learning function of FIG. 1, in accordance with the exemplary embodiment.

### DETAILED DESCRIPTION

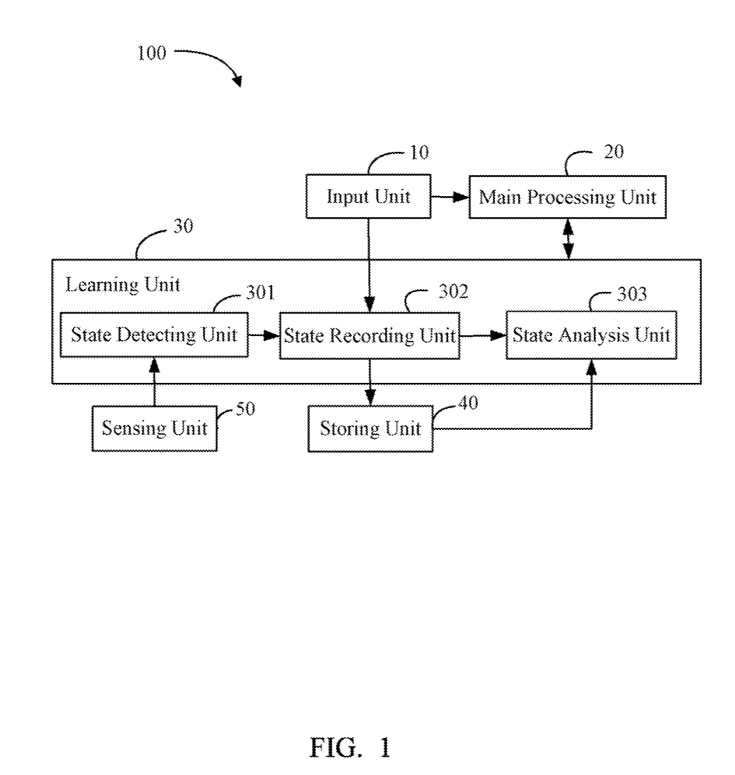

Referring to FIG. 1, an electronic device 100 with self-learning function is disclosed as an exemplary embodiment. The electronic device 100 is designed to track the users' habits of operation of the electronic device 100 and to adjust itself to match the users' habits. The electronic device 100 includes an input unit 10, a main processing unit 20, a learning unit 30, a storing unit 40 and a sensing unit 50. The learning unit 30 includes a state detecting unit 301 connecting with the sensing unit 50, a state recording unit 302 and a state analysis unit 303. Both of the state recording unit 302 and a state analysis unit 303 connect to the storing unit 40. The sensing unit 50 includes a time sensing unit, a temperature sensing unit, a light sensing unit, and a noise sensing unit. The sensing unit 50 is configured for detecting the real-time values of the state parameters, and transmitting the real-time values to the state detecting unit 301. In this embodiment, the electronic device 100 is an LED lamp. The state parameters are corresponding to the operations of the user to the electronic device 100. For example, the state parameter is the time for powering on/off under the powering on/off operation applied on the electronic device 100, and the state parameter is the ambient light intensity under the adjusting brightness operation applied on the electronic device 100. In another embodiment, the electronic device 100 may be an electronic reader, a digital photo frame, or a media player.

The input unit 10 is configured for generating input signals according to the operations of a user, and transmitting the input signals to the main processing unit 20 and the state recording unit 302. In this embodiment, the input unit 10 can be used for controlling the power on/off, or adjusting the brightness of the electronic device 100. In other embodiments, the input unit 10 may be a power control unit, a display brightness adjusting unit, or a volume adjusting unit of an electronic device.

The main processing unit 20 is configured for receiving the input signals transmitted from the input unit 10 and executing the tasks or commanding function components of the electronic device 100 to execute the tasks corresponding to the received input signals.

The state detecting unit 301 is configured for detecting the real time values of the state parameters of the electronic device 100 when the input signals are received. The state detecting unit 301 is also configured for transmitting a trigger signal to the main processing unit 20 when the detected real-time state parameter value is equal to the state parameter value of the habit, or falls in the state parameter value range of the habit.

The state recording unit 302 is configured for receiving the input signals transmitted from the input unit 10, and obtaining the real time values of the predetermined state parameters from the state detecting unit 301. The state recording unit 302 is also configured for recording the operations of the user and the real time values of the predetermined state parameters corresponding to the operations in the storing unit 40. For example, users are used to turning on or turning off the electronic device 100 at a regular time, thus the predetermined state parameters corresponding to the operations for turning on and turning off the electronic device 100 are the power on and power off time. Accordingly, the state recording unit 302 records a “power on” operation, a “power off” operation, a “power on” time and a “power off” time, the “power on” operation corresponds to the “power on” time and the “power off” operation corresponds to the “power off” time. Therefore, if the user powers on and off the electronic device 100 regularly recently, the electronic device 100 will learn this habit of the user and practice the user's habit afterwards. That is, the electronic device 100 will automatically power on and off at the corresponding “power on” time and “power off” time, this saves the user's time and facilitates the users. In another example, users are used to dimming the electronic device 100 when the ambient light intensity goes beyond a particular level, the electronic device 100 will learn this habit of the user and automatically adjust itself when the ambient light intensity goes beyond the particular level.

The electronic device 100 learns a habit of the user only when the habit is a “habit”, a “habit” in the exemplary embodiment means that an operation is repeated under the same condition (i.e., under the same state parameter value or values) for at least one time in a predetermined period. For example, in a predetermined period of 7 days, if the user powers on the electronic device 100 at 8 o'clock two times or more, “power on at 8 o'clock” is a habit. If the user dims the electronic device 100 when the ambient light intensity goes beyond 200 lumens per watt for two times or more, “dimming when the ambient light intensity goes beyond 200 lumens per watt” is a habit. The state analysis unit 303 is configured for analyzing which type of operations is a habit according to the times of the operations repeats under a same state parameter value or values within a predetermined time period. If an operation is repeated for a predetermined number of times within the predetermined time period, this operation is a habit. The state analysis unit 303 is also configured for recording the habits of the users, i.e., the operations and the state parameter value or values in the storing unit 40.

Take the operation for powering on the electronic device 100 for example, the user powers on the electronic device 100 at 8 o'clock more than three times within the predetermined period of 7 days, the state recording unit 302 records the “power on” operation, the “power on” time 8 o'clock corresponding to the “power on” operation. The state analysis unit 303 determines the operation for powering on the electronic device 100 at 8 o'clock is a habit of the user according to the data record in the state recording unit 302. The state analysis unit 303 records the habit of the user in the storing unit 40, that is, records the operation of powering on the electronic device 100 at 8 o'clock in the storing unit 40. Otherwise, the state analysis unit 303 determines the operation for powering on the electronic device 100 at 8 o'clock is not a habit of the user, when the state analysis unit 303 determines that the user powers on the electronic device 100 at 8 o'clock less than or equal to three times within the predetermined period of 7 days. In another example, the state analysis unit 303 determines the operation for powering on the electronic device 100 at 10 o'clock is a habit of the user, when the state analysis unit 303 determines that the user powers on the electronic device 100 at 10 o'clock more than five times within the predetermined period of 7 days.

In an alternative embodiment, the state analysis unit 303 is configured for analyzing which type of operations is a habit according to the times of the operations repeats in a same state parameter value range or ranges within a predetermined time period. If an operation is repeated for a predetermined number of times in the same state parameter value range or ranges within the predetermined time period, this operation is a habit. The state analysis unit 303 is also configured for recording the habits of the users, i.e., the operations and the state parameter value range or ranges in the storing unit 40.

Also take the operation for powering on the electronic device 100 for example, the user powers on the electronic device 100 between 8 o'clock and 9 o'clock more than three times within the predetermined period of 7 days, the state recording unit 302 records the “power on” operation, the “power on” time range from 8 o'clock to 9 o'clock corresponding to the “power on” operation. In the embodiment, the span of the state parameter value range is one hour. The state analysis unit 303 determines the operation for powering on the electronic device 100 between 8 o'clock and 9 o'clock is a habit of the user, according to the data record in the state recording unit 302. The state analysis unit 303 records the habit of the user in the storing unit 40, that is, the operation of powering on the electronic device 100 between 8 o'clock and 9 o'clock in the storing unit 40. Otherwise, the state analysis unit 303 determines the operation for powering on the electronic device 100 between 8 o'clock and 9 o'clock is not a habit of the user, when the state analysis unit 303 determines that the user powers on the electronic device 100 between 8 o'clock and 9 o'clock less than or equal to three times within the predetermined period of 7 days. In the embodiment, the state analysis unit 303 determines a time between 8 o'clock and 9 o'clock to be the power on time. The main processing unit 20 controls the electronic device 100 to learn this habit of the user and automatically powers itself on at a time between 8 o'clock and 9 o'clock. In another embodiment, the state analysis unit 303 determines the median 8:30 to be the power on time.

In the embodiment, if the user powers on the electronic device 100 between 9 o'clock and 10 o'clock more than three times within the predetermined period of 7 days, the state recording unit 302 records the “power on” operation and the “power on” time range from 9 o'clock to 10 o'clock corresponding to the “power on” operation. The state analysis unit 303 determines the operation for powering on the electronic device 100 between 9 o'clock and 10 o'clock is a habit of the user according to the data record in the state recording unit 302. The state analysis unit 303 records the habit of the user in the storing unit 40, that is, records the operation of powering on the electronic device 100 between 9 o'clock and 10 o'clock in the storing unit 40. In the embodiment, the state analysis unit 303 determines a particular time between 9 o'clock and 10 o'clock to be the power on time. The main processing unit 20 controls the electronic device 100 to learn this habit of the user and automatically power on itself at the particular time between 9 o'clock and 10 o'clock. In another embodiment, the state analysis unit 303 determines 9:30 to be the power on time.

Taking the operation for adjusting the brightness of the electronic device 100 for example, if the user dims the electronic device 100 when the ambient light intensity goes beyond 200 lumens per watt for more than two times within a predetermined period of 7 days. The state analysis unit 303 determines the operation for dimming the brightness of the electronic device 100 when the ambient light intensity goes beyond 200 lumens per watt is a habit, according to the data record in the state recording unit 302. The state analysis unit 303 stores the habit and the state parameter value 200 in the storing unit 40. The electronic device 100 learns this habit of the user and automatically dims itself when the ambient light intensity goes beyond 200 lumens per watt.

The state detecting unit 301 obtains the habit and the corresponding state parameter value or value range, and detects the real-time state parameter value of the electronic device 100. The state detecting unit 301 also transmits a trigger signal to the main processing unit 20, when the detected real-time state parameter value is equal to the state parameter value of the habit, or falls in the state parameter value range of the habit. The main processing unit 20 controls the electronic device 100 to learn this habit of the user and automatically executes the tasks or command components of the electronic device 100 to execute the tasks corresponding to the habit.

The electronic device 100 also allows the user to delete or change the habit and the corresponding state parameter value or value range stored in the storing unit 40.

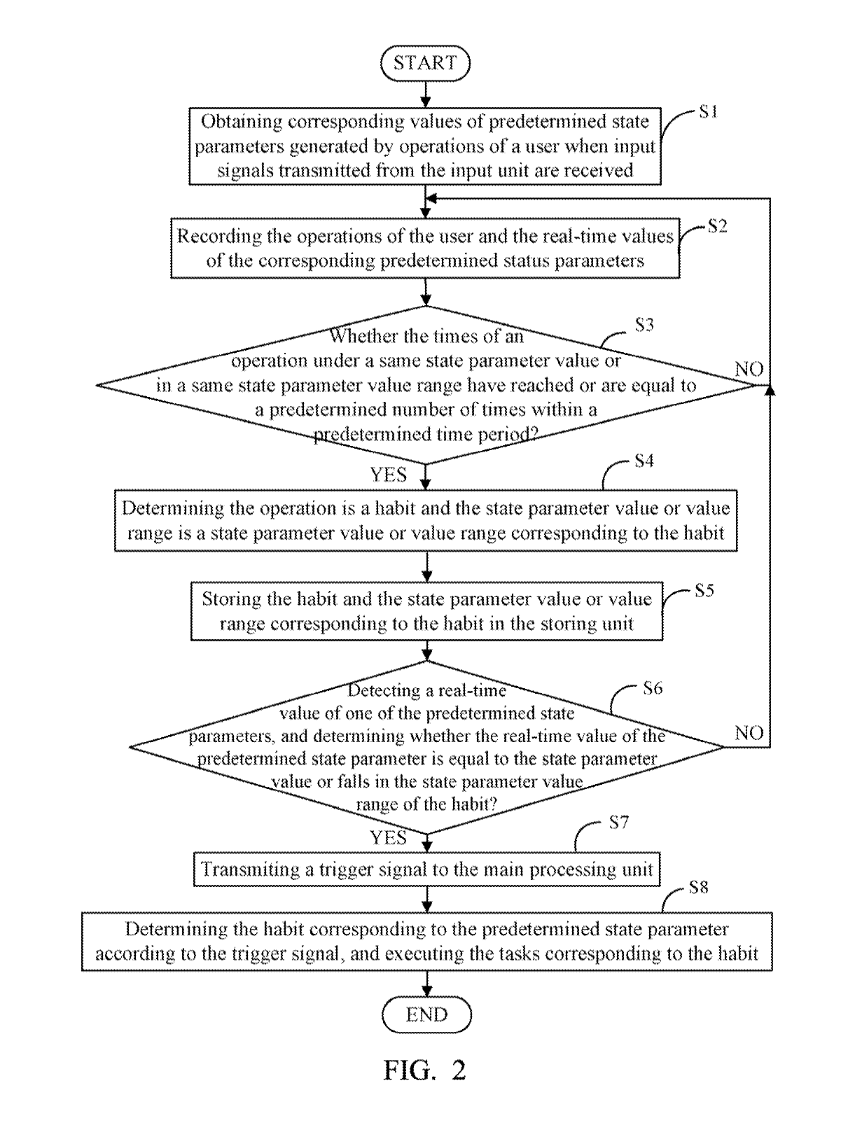

Referring to FIGS. 1 and 2, FIG. 2 shows a flowchart of an intelligent control method of the electronic device 100 with self-learning function of FIG. 1. The method includes the following steps, each of which is tied to various components contained in the electronic device 100 as shown in FIG. 1.

In step S1, the state recording unit 302 obtains corresponding values of predetermined state parameters generated by operations of a user when input signals transmitted from the input unit 10 are received.

In step S2, the state recording unit 302 records the operations of the user and real-time values of the corresponding predetermined status parameters in the storing unit 40.

In step S3, the state analysis unit 303 analyzes whether the times of an operation under a same state parameter value or in a same state parameter value range have reached or are equal to a predetermined number of times within a predetermined time period, if yes, the process goes to step S4, otherwise, the process goes back to step S2.

In step S4, the state analysis unit 303 determines the operation is a habit and the state parameter value or value range is a state parameter value or value range corresponding to the habit.

In step S5, the state analysis unit 303 stores the habit and the state parameter value or value range corresponding to the habit in the storing unit 40.

In step S6, the state detecting unit 301 detects a real-time value of one of the predetermined state parameters, and determines whether the real-time value of the predetermined state parameter is equal to the state parameter value or falls in the state parameter value range of the habit. If no, the process goes back to step S2, if yes, the process goes to step S7.

In step S7, the state detecting unit 301 transmits a trigger signal to the main processing unit 20.

In step S8, the main processing unit 20 determines the habit corresponding to the state predetermined parameter according to the trigger signal, and executes the tasks corresponding to the habit.

With such configuration, the electronic device 100 tracks the users' habits of operation of the electronic device 100 and adjusts itself to match the users' habits, which saves users' time and is much more convenient for users.

Although the present disclosure has been specifically described on the basis of the embodiments thereof, the disclosure is not to be construed as being limited thereto. Various changes or modifications may be made to the embodiments without departing from the scope and spirit of the disclosure.

What is claimed is:

1. An electronic device with self-learning function, comprising:
an input unit configured for generating input signals according to operations of a user;
a state detecting unit configured for detecting real-time values of state parameters of the electronic device;
a state recording unit configured for obtaining the real-time values of predetermined state parameters generated by the operation when the input signals are received;
a state analysis unit configured for analyzing whether the times an operation repeats under a same state parameter value have reached or are equal to a predetermined number of times within a predetermined time period, and determining the operation is a habit and the state parameter value corresponding to the operation is the state parameter value of the habit when the times the operation repeats under a same state parameter value have reached or are equal to the predetermined number of times within the predetermined time period; and
a processing unit;
wherein the state detecting unit transmits a trigger signal to the processing unit when the detected real-time state parameter value is equal to the state parameter value of the habit, and the processing unit executes a task corresponding to the habit.

2. The electronic device as described in claim 1, further comprising a storing unit connected with the state recording unit and the state analysis unit, wherein the state recording unit is also configured for recording the habits of the user and the values of the predetermined state parameters corresponding to the habits in the storing unit.

3. The electronic device as described in claim 1, further comprising a sensing unit connecting with the state detecting unit, configured for detecting the real-time values of the state parameters, and transmitting the detection results to the state detecting unit.

4. The electronic device as described in claim 1, wherein the electronic device is an LED lamp, an electronic reader, a digital photo frame, or a media player.

5. An electronic device with self-learning function, comprising:
an input unit configured for generating input signals according to operations of a user;
a state detecting unit configured for detecting real-time values of state parameters of the electronic device;
a state recording unit configured for obtaining the real-time values of predetermined state parameters generated by the operation when the input signals are received;
a state analysis unit configured for analyzing whether the times the operations repeats in same state parameter value range have reached or are equal to a predetermined number of times within a predetermined time period, and determining the operation is a habit and the state parameter value range is the state parameter value range of the habit when the times the operations repeats in a same state parameter value range have reached or are equal to a predetermined number of times within a predetermined time period; and
a processing unit;
wherein the state detecting unit transmits a trigger signal to the processing unit when the detected real-time state parameter value falls in the state parameter value range of the habit, and the processing unit executes a task corresponding to the habit.

6. The electronic device as described in claim 5, further comprising a storing unit connected with the state recording unit and the state analysis unit, wherein the state recording unit is also configured for recording the habits of the user and the values of the predetermined state parameters corresponding to the habits in the storing unit.

7. The electronic device as described in claim 5, further comprising a sensing unit connecting with the state detecting unit, configured for detecting the real-time values of the state parameters, and transmitting the detection results to the state detecting unit.

8. The electronic device as described in claim 5, wherein the electronic device is an LED lamp, an electronic reader, a digital photo frame, or a media player.

9. An intelligent control method of an electronic device, comprising:
obtaining corresponding values of predetermined state parameters generated by operations of a user when input signals are received;
recording the operations of the user and real-time values of the corresponding predetermined status parameters;
analyzing whether the times of an operation under a same state parameter value or in a same state parameter value range have reached or are equal to a predetermined number of times within a predetermined time period;
determining the operation is a habit and the state parameter value or value range is a state parameter value or value range of the habit when the times of an operation under a same state parameter value or in a same state parameter value range have reached or are equal to a predetermined number of times within a predetermined time period;
detecting a real-time value of one of the predetermined state parameters, and determining whether the real-time value of the predetermined state parameter is equal to the state parameter value or falls in the state parameter value range of the habit;
transmitting a trigger signal when the real-time value of the predetermined state parameter is equal to the state parameter value or falls in the state parameter value range of the habit; and
executing a task corresponding to the habit.

10. The method as described in claim 10, further comprising the step of determining the habit corresponding to the predetermined state parameter according to the trigger signal.

11. The method as described in claim 10, further comprising the step of storing the habit and the state parameter value or value range of the habit.
